(19) United States
(12) Patent Application Publication
(10) Pub. No.: US 2024/0337970 A1
(43) Pub. Date: Oct. 10, 2024

(54) PRESSURE-BONDING DEVICE FOR PRESSURE-BONDING PRESSURE-BONDABLE TONER SURFACES TO EACH OTHER

(71) Applicant: FUJIFILM Business Innovation Corp., Tokyo (JP)

(72) Inventors: Tomokazu KURITA, Kanagawa (JP); Masahiko KUBO, Kanagawa (JP); Takeharu NAGAI, Kanagawa (JP)

(73) Assignee: FUJIFILM Business Innovation Corp., Tokyo (JP)

(21) Appl. No.: 18/614,716

(22) Filed: Mar. 24, 2024

(30) Foreign Application Priority Data
Apr. 10, 2023 (JP) 2023-063343

(51) Int. Cl. G03G 15/20

(52) U.S. Cl. CPC G03G 15/2039; G03G 15/2021; G03G 15/2064; G03G 2215/2006

(57) ABSTRACT

A pressure-bonding device that pressure-bonds pressure-bondable toner surfaces to each other which are surfaces of a printing medium on which pressure-bondable toners are formed includes: a pair of rollers that applies a pressure to pressure-bondable surfaces, on which the pressure-bondable toner surfaces of the printing medium face each other, by sandwiching the printing medium in a nip portion; and a heating control mechanism that heats the nip portion.

### CROSS-REFERENCE TO RELATED APPLICATIONS

This application is based on and claims priority under 35 USC 119 from Japanese Patent Application No. 2023-063343 filed Apr. 10, 2023.

### BACKGROUND

### (i) Technical Field

The present invention relates to a pressure-bonding device that pressure-bonds pressure-bondable toner surfaces to each other.

### (ii) Related Art

A pressure-bonded printed matter (such as a pressure-bonded postcard), in which pressure-bondable surfaces are pressure-bonded to each other, is known. In the related art, a pressure-bondable toner capable of exhibiting a pressure-bonding function has been proposed. According to the pressure-bondable toner, a pressure-bonded printed matter can be formed without separately using an adhesive such as glue.

For example, JP2021-18422A discloses a printed matter production system that forms a pressure-bondable toner, which is a toner including pressure-responsive particles that exhibit adhesiveness by applying pressure, on a printing medium to pressure-bond pressure-bondable toner surfaces, on which the pressure-bondable toners of the printing medium are formed, to each other through a pressurizing device. JP2008-225042A discloses a method of producing a pressure-sensitive adhesive sheet in which a printing medium on which a pressure-sensitive adhesive toner and a color toner are formed is heated and pressurized such that the pressure-sensitive adhesive toner and the color toner are fixed on the printing medium.

### SUMMARY

Meanwhile, it is necessary that the pressure-bondable toner surfaces, which are the surfaces of the printing medium on which the pressure-bondable toner is formed, are more reliably pressure-bonded to each other. Here, the pressure for pressure-bonding the pressure-bondable toner surfaces to each other is simply increased. Therefore, the pressure-bondable toner surfaces can be more reliably pressure-bonded to each other. However, in such a case, the possibility of occurrence of deformation or damage of the printing medium also increases.

Aspects of non-limiting embodiments of the present disclosure relate to a pressure-bonding device that more reliably pressure-bond the pressure-bondable toner surfaces to each other while reducing the possibility of occurrence of deformation or damage of the printing medium, as compared with a case of simply increasing the pressure for pressure-bonding the pressure-bondable toner surfaces to each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a pressure-bonding device that pressure-bonds pressure-bondable toner surfaces to each other which are surfaces of a printing medium on which pressure-bondable toners are formed, the pressure-bonding device including: a pair of rollers that applies a pressure to pressure-bondable surfaces, on which the pressure-bondable toner surfaces of the printing medium face each other, by sandwiching the printing medium in a nip portion; and a heating control mechanism that heats the nip portion.

### BRIEF DESCRIPTION OF THE DRAWINGS

Exemplary embodiment(s) of the present invention will be described in detail based on the following figures, wherein:

FIG. 1 is a schematic configuration diagram of a pressure-bonded printed matter forming system according to a present exemplary embodiment;

FIG. 2 is a conceptual diagram showing a pressure-bondable toner;

FIG. 3 is a diagram showing a folded printing medium;

FIG. 4 is a schematic configuration diagram of a pressure-bonding device; and

FIG. 5 is a schematic configuration diagram showing a modification example of the pressure-bonding device.

### DETAILED DESCRIPTION

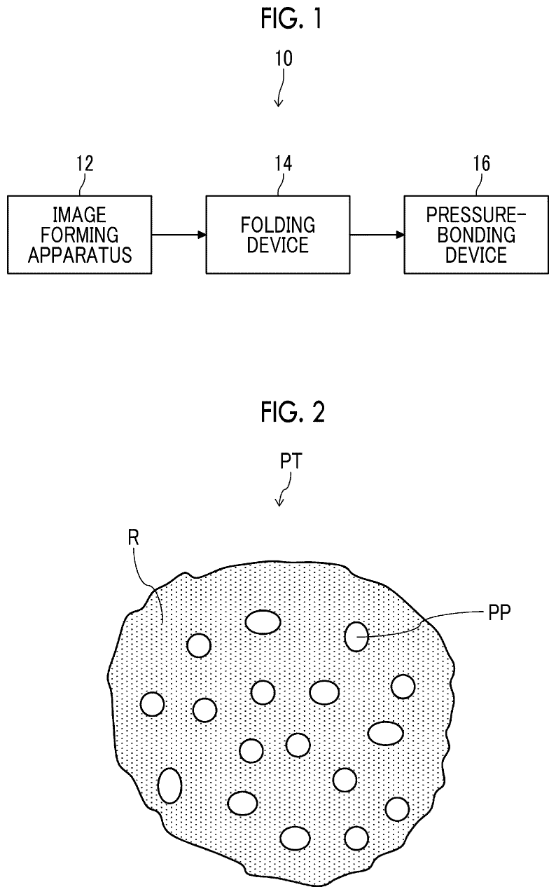

FIG. 1 is a schematic configuration diagram of a pressure-bonded printed matter forming system 10 according to a present exemplary embodiment. The pressure-bonded printed matter forming system 10 is a system for forming a pressure-bonded printed matter (for example, a pressure-bonded postcard) in which pressure-bondable surfaces are pressure-bonded to each other. The pressure-bonded printed matter forming system 10 is configured to include an image forming apparatus 12, a folding device 14, and a pressure-bonding device 16.

The image forming apparatus 12 is an apparatus that executes a printing process of forming an image on a printing medium such as paper. In the present exemplary embodiment, the image forming apparatus 12 is a laser printer. The image forming apparatus 12 sequentially transfers, for example, each color toner of cyan (C), magenta (M), yellow (Y), and black (K) (or to which a special color is added) onto a printing medium, and then heats and pressurizes the color toner transferred onto the printing medium, thereby fixing the color toner onto the printing medium. Thereby, an image is formed on the printing medium.

In the present exemplary embodiment, the image forming apparatus 12 forms a pressure-bondable toner on the printing medium in addition to the color toners. The pressure-bondable toner is a toner which exhibits an adhesive function. FIG. 2 is a conceptual diagram showing a pressure-bondable toner PT. The pressure-bondable toner PT is a resin R corresponding to a toner material in the related-art mixed with pressure-responsive particles PP. The pressure-responsive particles PP each are resin having a characteristic of softening in a case where a pressure is applied to the resin. The pressure-responsive particle PP is configured to include a styrene-based resin which includes styrene and other vinyl monomers as polymerization components and a (meth) acrylic acid ester-based resin which includes at least two kinds of (meth) acrylic acid esters as polymerization components and in which a ratio of a mass of the (meth) acrylic acid esters to a total mass of polymerization components is 90% by mass or more. In a case where a pressure is applied, the pressure-responsive particles PP of the pressure-bondable toner PT soften due to the pressure, thereby exhibiting the adhesive function.

In the present exemplary embodiment, the pressure-bondable toner is a transparent-color toner (specifically, the resin R described above is a transparent resin) and is formed on the printing medium so as to cover the color toner. A portion, on which the pressure-bondable toner is formed, functions as a portion that exerts an adhesive function by being applied with a pressure by a pressure-bonding device 16 described later. It should be noted that the pressure-bondable toner does not necessarily have to have a transparent color. For example, the color toner of any one of C, M, Y, K, or a special color may be a pressure-bondable toner. That is, the pressure-bondable toner PT may be a mixture of the resin R, which is a colored resin, and the pressure-responsive particles PP. In such a case, it is not necessary to separately provide the pressure-bondable toner for the color toners such as C, M, Y, and K.

The printing medium, on which the color toners and the pressure-bondable toners PT are formed, is sent to the folding device 14.

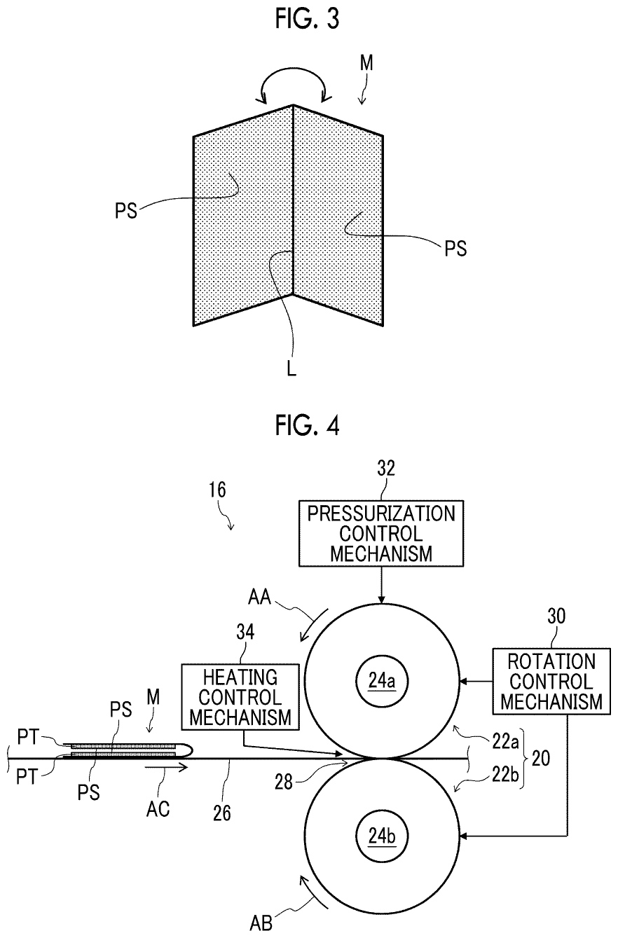

The folding device 14 executes a process of folding the printing medium on which the color toners and the pressure-bondable toners PT are formed by the image forming apparatus 12. Since a specific structure of the folding device 14 may be the same as a specific structure of the folding device in the related art, detailed description thereof will not be repeated here. As a folding method therefor, for example, there are various types such as V-folding, Z-folding, and L-folding. A user may be able to specify the folding method. In the present exemplary embodiment, the folding device 14 folds the printing medium such that the pressure-bondable toner surfaces, which are a surface of the printing medium on which the pressure-bondable toners PT are formed, face each other. For example, in the case of V-folding, as shown in FIG. 3, the pressure-bondable toner surface PS is valley-folded at the fold line L so as to be the inner side surface.

A printing medium M, which is folded such that the pressure-bondable toner surfaces PS face each other, is sent to the pressure-bonding device 16.

The pressure-bonding device 16 is an apparatus that pressure-bonds the pressure-bondable toner surfaces PS to each other by applying pressure to the pressure-bondable surface as a surface on which the pressure-bondable toner surfaces PS of the printing medium M face each other.

FIG. 4 is a schematic configuration diagram of the pressure-bonding device 16. The pressure-bonding device 16 includes a pair of rollers 20. The pair of rollers 20 is configured to include a cylindrical roller 22a and a roller 22b. FIG. 2 shows the bottom surfaces of the roller 22a and the roller 22b. The roller 22a rotates about a roller shaft 24a in the direction indicated by an arrow AA, and the roller 22b rotates about a roller shaft 24b in the direction indicated by an arrow AB in the direction opposite to the roller 22a. The roller 22a and the roller 22b are provided to sandwich a conveying belt 26 that conveys the printing medium M. Thereby, the roller 22a and the roller 22b form a nip portion 28 which is a portion in which the roller 22a and the roller 22b face each other with the conveying belt 26 interposed therebetween. The conveying belt 26 is an endless-track belt, and is moved in the direction indicated by an arrow AC by a driving roller (not shown in the drawing). Although details will be described later, the pair of rollers 20 applies a pressure to the pressure-bondable surfaces of the printing medium M by sandwiching the printing medium M in the nip portion 28.

The pressure-bonding device 16 includes a rotation control mechanism 30. The rotation control mechanism 30 is a mechanism that controls rotation and stop of the pair of rollers 20. The rotation control mechanism 30 may control, for example, a speed of rotation of the pair of rollers 20. The rotation control mechanism 30 is configured to include, for example, a motor that rotates the roller shafts 24a and 24b, a processor that controls the speed of rotation of the motor, and the like.

The pressure-bonding device 16 includes a pressurization control mechanism 32. The pressurization control mechanism 32 is a mechanism that controls the pressure, which is applied to the pressure-bondable surfaces of the printing medium M by the pair of rollers 20. The pressurization control mechanism 32 is configured to include, for example, an elastic member (for example, a spring) that exerts an elastic force for pressing the roller 22a against the roller 22b, an actuator for changing the elastic force of the elastic member, a processor for controlling the actuator, and the like. In the present exemplary embodiment, the pressure applied by the pair of rollers 20 to the pressure-bondable surfaces of the printing medium M is in a range of about 500 kgf/cm² to 1,000 kgf/cm².

Further, the pressure-bonding device 16 includes a heating control mechanism 34. The heating control mechanism 34 is a mechanism that heats the nip portion 28 of the pair of rollers 20. In other words, the heating control mechanism 34 is a mechanism that heats the pressure-bondable surfaces of the printing medium M sandwiched in the nip portion 28. For example, the heating control mechanism 34 may be capable of controlling an amount of heating to the nip portion 28. The amount of heating to the nip portion 28 may be set to be equal to or lower than, for example, a glass transition temperature (for example, 50° C. to 60° C.) of the pressure-responsive particles PP.

As the configurations of the heating control mechanism 34, various configurations may be adopted. For example, the heating control mechanism 34 is configured to include a first heat generation roller that is external to the roller 22a, a second heat generation roller that is external to the roller 22b, a heat source that heats the first heat generation roller and the second heat generation roller, and a processor that controls the amount of heat generated by the heat source. With such a configuration, the heat from the heat source is transferred onto the surfaces of the roller 22a and the roller 22b via the first heat generation roller and the second heat generation roller, and thus the nip portion 28 is heated. An aspect in which either one of the first heat generation roller or the second heat generation roller is provided may be adopted.

Alternatively, the heating control mechanism 34 is configured to include a heat source that heats at least one of the roller shaft 24a or the roller shaft 24b, and a processor that controls an amount of heat generated by the heat source. With such a configuration, the heat from the heat source is transmitted to the surfaces of the roller 22a and the roller 22b via the roller shaft 24a or the roller shaft 24b, and thus the nip portion 28 is heated.

The configuration of the heating control mechanism 34 is not limited to the above-mentioned example, and any configuration may be used as long as the nip portion 28 can be heated.

The overview of the configuration of the pressure-bonding device 16 of the present exemplary embodiment is as described above. Hereinafter, the effect of the pressure-bonding device 16 will be described. The printing medium M, which is folded such that the pressure-bondable toner surfaces PS face each other, is placed on the upstream side of the nip portion 28 on the conveying belt 26. In a case where the conveying belt 26 moves in this state, the printing medium M moves in the direction of the arrow AC and is eventually sandwiched in the nip portion 28. The pair of rollers 20 applies a pressure to the pressure-bondable surfaces of the printing medium M by sandwiching the printing medium M in the nip portion 28. By applying the pressure from the pair of rollers 20, the pressure-bondable toner surfaces PS are pressure-bonded to each other, and a pressure-bonded printed matter is formed.

Here, in the present exemplary embodiment, the heating control mechanism 34 heats the nip portion 28. That is, the pressure-bondable surfaces of the printing medium M are pressurized by the pair of rollers 20 and heated by the heating control mechanism 34. The pressure-responsive particles PP included in the pressure-bondable toner PT have a characteristic that the higher the temperature, the softer the particles PP with a smaller pressure (that is, exhibiting an adhesive function). Therefore, by heating the nip portion 28, in other words, the pressure-bondable surfaces of the printing medium M through the heating control mechanism 34, the pressure, which is applied to the pressure-bondable surfaces of the printing medium M by the pair of rollers 20, is not necessary to be so large. Therefore, the pressure-bondable toner surfaces PS can be sufficiently pressure-bonded to each other. That is, by heating the pressure-bondable surfaces of the printing medium M, the pressure-bondable toner surfaces PS can be more reliably pressure-bonded to each other while the possibility of occurrence of deformation or damage of the printing medium M is reduced. Further, the pressure, which is applied to the pressure-bondable surfaces of the printing medium M by the pair of rollers 20, may be set to be constant. In such a case, by heating the pressure-bondable surfaces of the printing medium M, the pressure-bondable toner surfaces PS may be more reliably pressure-bonded to each other as compared with a case where the pressure-bondable surfaces of the printing medium M are not heated.

In a case where a large amount of heating is applied to the pressure-bondable surfaces of the printing medium M, an image formed on the printing medium M (particularly, the pressure-bondable surface) may be deteriorated. For example, the image may be glossy (shiny) or the image may be blurred. On the other hand, as described above, in a case where a large amount of pressure is applied to the pressure-bondable surfaces of the printing medium M, the printing medium M may be deformed or damaged. Therefore, for example, the pressurization control mechanism 32 and the heating control mechanism 34 may apply a pressure and a heat to the pressure-bondable surfaces of the printing medium M in a well-balanced manner. Specifically, the pressure-responsive particles PP are characterized in that the higher the temperature, the softer the particles PP with a smaller pressure. Therefore, the pressurization control mechanism 32 may reduce the pressure, which is applied to the pressure-bondable surfaces of the printing medium M by the pair of rollers 20, in response to, for example, an increase in amount of heating of the nip portion 28 performed by the heating control mechanism 34. Alternatively, the pressurization control mechanism 32 may increase the pressure, which is applied to the pressure-bondable surfaces of the printing medium M by the pair of rollers 20, in response to, for example, a decrease in amount of heating of the nip portion 28 performed by the heating control mechanism 34.

Further, in the pressure-bonding device 16, the rotation control mechanism 30 controls an amount of rotation of the pair of rollers 20. The smaller the amount of rotation of the pair of rollers 20 is, the longer time it takes for the pair of rollers 20 to apply pressure to the pressure-bondable surfaces of the printing medium M. That is, the rotation control mechanism 30 is able to adjust a time for which the pair of rollers 20 applies the pressure to the pressure-bondable surfaces of the printing medium M. For example, the rotation control mechanism 30 may determine the amount of rotation of the pair of rollers 20 (that is, the time for which the pair of rollers 20 applies the pressure to the pressure-bondable surfaces of the printing medium M), on the basis of the paper type of the printing medium M, the image formed on the printing medium M, the temperature or humidity of the nip portion 28, or the like.

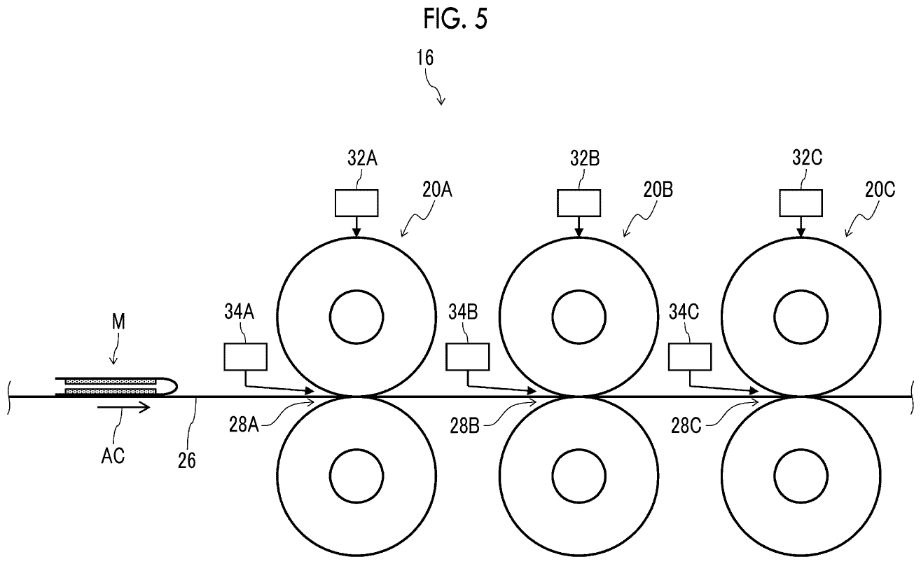

FIG. 5 is a schematic configuration diagram showing a modification example of the pressure-bonding device 16. The pressure-bonding device 16 according to the modification example has a plurality of pairs of rollers 20. In the example of FIG. 5, the pressure-bonding device 16 has three pairs of rollers 20 including pair of rollers 20A, pair of rollers 20B, and pair of rollers 20C, but the number of pairs of rollers 20 may be two, or may be four or more.

Similar to the above-mentioned present exemplary embodiment, each of the pairs of rollers 20 is provided with the rotation control mechanism 30, the pressurization control mechanism 32, and the heating control mechanism 34. In the example of FIG. 5, specifically, the pair of rollers 20A is provided with a rotation control mechanism (not shown in the drawing) that controls the rotation of the pair of rollers 20A, a pressurization control mechanism 32A that controls a pressure which is applied to the pressure-bondable surfaces of the printing medium M by the pair of rollers 20A, and a heating control mechanism 34A that controls the amount of heating to the nip portion 28A of the pair of rollers 20A. The pair of rollers 20B is provided with a rotation control mechanism (not shown in the drawing) that controls the rotation of the pair of rollers 20B, a pressurization control mechanism 32B that controls a pressure which is applied to the pressure-bondable surfaces of the printing medium M by the pair of rollers 20B, and a heating control mechanism 34B that controls an amount of heating to the nip portion 28B of the pair of rollers 20B. The pair of rollers 20C is provided with a rotation control mechanism (not shown in the drawing) that controls the rotation of the pair of rollers 20C, a pressurization control mechanism 32C that controls a pressure which is applied to the pressure-bondable surfaces of the printing medium M by the pair of rollers 20C, and a heating control mechanism 34C that controls an amount of heating to the nip portion 28C of a pair of rollers 20C.

The plurality of pairs of rollers 20 are provided along the conveying belt 26, in other words, along the conveyance direction of the printing medium M. In the example of FIG. 5, the pair of rollers 20A is disposed in the order of pair of rollers A, pair of rollers B, and pair of rollers C from the upstream side to the downstream side in the conveyance direction of the printing medium M.

In the pressure-bonding device 16 according to the modification example, in a case where the conveying belt 26 moves, the printing medium M moves in the direction of the arrow AC and is sequentially sandwiched in the nip portions 28 of the plurality of pairs of rollers 20. That is, the plurality of pairs of rollers 20 sequentially apply pressures to the pressure-bondable surfaces of the printing medium M. At the same time, each of the heating control mechanisms 34 provided on the plurality of pairs of rollers 20 sequentially applies heat to the pressure-bondable surfaces of the printing medium M. In the pressure-bonding device 16 according to the modification example, the plurality of pairs of rollers 20 sequentially apply pressure and heat to the pressure-bondable surfaces of the printing medium M. Therefore, as compared with a case where one pair of rollers 20 applies pressure and heat to the pressure-bondable surfaces of the printing medium M, the pressure-bondable toner surfaces PS can be more reliably pressure-bonded to each other.

Here, for example, the pair of rollers 20, which is disposed on the downstream side in the conveyance direction of the printing medium M, may apply a pressure, which is greater than a different pair of rollers 20 disposed on the upstream side of the pairs of rollers 20, to the pressure-bondable surfaces of the printing medium M. In the portion of the pressure-bondable toner PT including a large amount of pressure-responsive particles PP (refer to FIG. 2), unreacted (not softened) pressure-responsive particles PP may remain in a case where strong pressure is applied thereto only once. In particular, the pressure-responsive particles PP formed on the printing medium M, which are not on the front surface side of the pressure-bondable toner PT but on the inner side, may remain unreacted. Therefore, by gradually applying the strong pressure to the plurality of pairs of rollers 20, the number of unreacted pressure-responsive particles PP is reduced while the possibility of occurrence of deformation or damage of the printing medium is reduced M. That is, a more stable (less variation) adhesive function of the pressure-bondable toner PT can be exhibited.

Specifically, in the example of FIG. 5, the pressurization control mechanism 32A controls a pressure P_{A}, which is applied to the pressure-bondable surfaces of the printing medium M by the pair of rollers 20A. In such a case, the pressurization control mechanism 32B controls a pressure P_{B}, which is applied to the pressure-bondable surfaces of the printing medium M by the pair of rollers 20B, such that P_{A}<P_{B}. Further, the pressurization control mechanism 32C controls a pressure P_{C}, which is applied to the pressure-bondable surfaces of the printing medium M by the pair of rollers 20C, such that P_{B}<P_{C}. In addition, in a case where the pressure-bonding device 16 has three or more pairs of rollers 20, it is not necessary to gradually increase the pressure, which is applied to the printing medium M by each of the pairs of rollers 20, from the upstream side to the downstream side in the conveyance direction of the printing medium M. For example, in the above-mentioned example, the pressure P_{A}, which is applied to the pressure-bondable surfaces of the printing medium M by the pair of rollers 20A, and the pressure P_{B}, which is applied to the pressure-bondable surfaces of the printing medium M by the pair of rollers 20B, may be equal to each other. That is, P_{A}=P_{B}<P_{C} may be established. Alternatively, in the above-mentioned example, the pressure P_{B}, which is applied to the pressure-bondable surfaces of the printing medium M by the pair of rollers 20B, and the pressure P_{C}, which is applied to the pressure-bondable surfaces of the printing medium M by the pair of rollers 20C, may be equal to each other. That is, P_{A}<P_{B}=P_{C} may be established.

Further, for example, the heating control mechanism 34 of each of the pairs of rollers 20 may make an amount of heating of the nip portion 28 of the pair of rollers 20, which is disposed on the downstream side in the conveyance direction of the printing medium M, smaller than an amount of heating of the nip portion 28 of the different pair of rollers 20 which is disposed on the upstream side of the pairs of rollers 20. As described above, in a case where the printing medium M is heated, an image, which is formed on the printing medium M, may be deteriorated. Therefore, by gradually reducing the heat applied to the printing medium M, deterioration of the image formed on the printing medium M can be suppressed while the pressure-bondable toner surfaces PS are more reliably pressure-bonded to each other.

Specifically, in the example of FIG. 5, in a case where the heating control mechanism 34A controls an amount of heating H_{A}, which is applied to the nip portion 28A by the pair of rollers 20A, the heating control mechanism 34B controls an amount of heating H_{B}, which is applied to the nip portion 28B of the pair of rollers 20B, such that H_{A}>H_{B}. Further, the heating control mechanism 34C controls an amount of heating H_{C}, which is applied to the nip portion 28C of the pair of rollers 20C, such that H_{B}>H_{C}. In addition, in a case where the pressure-bonding device 16 has three or more pairs of rollers 20, it is not necessary to gradually decrease the amount of heating applied to the nip portion 28 of each of the pairs of rollers 20 from the upstream side to the downstream side in the conveyance direction of the printing medium M. For example, in the above-mentioned example, the amount of heating H_{A}, which is applied to the nip portion 28A of the pair of rollers 20A, and the amount of heating H_{B}, which is applied to the nip portion 28B of the pair of rollers 20B, may be equal to each other. That is, H_{A}=H_{B}>H_{C} may be established. Alternatively, in the above-mentioned example, the amount of heating H_{B}, which is applied to the nip portion 28B of the pair of rollers 20B, and the amount of heating H_{C}, which is applied to the nip portion 28C of the pair of rollers 20C, may be equal to each other. That is, H_{A}>H_{B}=H_{C} may be established.

Although the exemplary embodiment of the present invention has been described above, the present invention is not limited to the exemplary embodiment and can be subjected to various changes without departing from the gist of the present invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

A pressure-bonding device that pressure-bonds pressure-bondable toner surfaces to each other which are surfaces of a printing medium on which pressure-bondable toners are formed, the pressure-bonding device comprising:
a pair of rollers that applies a pressure to pressure-bondable surfaces, on which the pressure-bondable toner surfaces of the printing medium face each other, by sandwiching the printing medium in a nip portion; and
a heating control mechanism that heats the nip portion.

(((2)))

The pressure-bonding device according to (((1))), further comprising:
a plurality of pairs of rollers that sequentially apply pressures to the pressure-bondable surfaces of the printing medium,
wherein the heating control mechanism heats the nip portion of each of the plurality of pairs of rollers.

(((3)))

The pressure-bonding device according to (((2))),
wherein the pair of rollers, which is disposed on a downstream side of the pairs of rollers in a conveyance direction of the printing medium, applies a pressure, which is greater than a pressure of a different pair of rollers disposed on an upstream side of the pairs of rollers, to the pressure-bondable surfaces of the printing medium.

(((4)))

The pressure-bonding device according to (((2))) or (((3))),
wherein the heating control mechanism makes an amount of heating of the nip portion of the pair of rollers, which is disposed on a downstream side of the pairs of rollers in a conveyance direction of the printing medium, smaller than an amount of heating of the nip portion of a different pair of rollers disposed on an upstream side of the pairs of rollers.

(((5)))

The pressure-bonding device according to any one of (((1))) to (((4))), further comprising:
a pressurization control mechanism that controls a pressure which is applied by the pair of rollers to the pressure-bondable surfaces of the printing medium,
wherein the heating control mechanism is capable of controlling an amount of heating to the nip portion.

(((6)))

The pressure-bonding device according to (((5))),
wherein the pressurization control mechanism decreases the pressure, which is applied by the pair of rollers to the pressure-bondable surfaces of the printing medium, in response to an increase in an amount of heating of the nip portion performed by the heating control mechanism.

(((7)))

The pressure-bonding device according to (((5))),
wherein the pressurization control mechanism increases the pressure, which is applied by the pair of rollers to the pressure-bondable surfaces of the printing medium, in response to a decrease in an amount of heating of the nip portion performed by the heating control mechanism.

(((8)))

The pressure-bonding device according to any one of (((1))) to (((7))), further comprising:
a rotation control mechanism that controls a speed of rotation of the pair of rollers.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A pressure-bonding device that pressure-bonds pressure-bondable toner surfaces to each other which are surfaces of a printing medium on which pressure-bondable toners are formed, the pressure-bonding device comprising:
a pair of rollers that applies a pressure to pressure-bondable surfaces, on which the pressure-bondable toner surfaces of the printing medium face each other, by sandwiching the printing medium in a nip portion; and
a heating control mechanism that heats the nip portion.

2. The pressure-bonding device according to claim 1, further comprising:
a plurality of pairs of rollers that sequentially apply pressures to the pressure-bondable surfaces of the printing medium,
wherein the heating control mechanism heats the nip portion of each of the plurality of pairs of rollers.

3. The pressure-bonding device according to claim 2,
wherein the pair of rollers, which is disposed on a downstream side of the pairs of rollers in a conveyance direction of the printing medium, applies a pressure, which is greater than a pressure of a different pair of rollers disposed on an upstream side of the pairs of rollers, to the pressure-bondable surfaces of the printing medium.

4. The pressure-bonding device according to claim 2,
wherein the heating control mechanism makes an amount of heating of the nip portion of the pair of rollers, which is disposed on a downstream side of the pairs of rollers in a conveyance direction of the printing medium, smaller than an amount of heating of the nip portion of a different pair of rollers disposed on an upstream side of the pairs of rollers.

5. The pressure-bonding device according to claim 3,
wherein the heating control mechanism makes an amount of heating of the nip portion of the pair of rollers, which is disposed on a downstream side of the pairs of rollers in a conveyance direction of the printing medium, smaller than an amount of heating of the nip portion of a different pair of rollers disposed on an upstream side of the pairs of rollers.

6. The pressure-bonding device according to claim 1, further comprising:
a pressurization control mechanism that controls a pressure which is applied by the pair of rollers to the pressure-bondable surfaces of the printing medium,
wherein the heating control mechanism is capable of controlling an amount of heating to the nip portion.

7. The pressure-bonding device according to claim 6,
wherein the pressurization control mechanism decreases the pressure, which is applied by the pair of rollers to the pressure-bondable surfaces of the printing medium, in response to an increase in an amount of heating of the nip portion performed by the heating control mechanism.

8. The pressure-bonding device according to claim 6,
wherein the pressurization control mechanism increases the pressure, which is applied by the pair of rollers to the pressure-bondable surfaces of the printing medium, in response to a decrease in an amount of heating of the nip portion performed by the heating control mechanism.

9. The pressure-bonding device according to claim 1, further comprising:
a rotation control mechanism that controls a speed of rotation of the pair of rollers.
